(19) United States
(12) Patent Application Publication
(10) Pub. No.: US 2025/0028846 A1
(43) Pub. Date: Jan. 23, 2025

(54) STORING PORTIONS OF DATA ACROSS MULTIPLE MACHINES

(71) Applicant: Wells Fargo Bank, N.A., San Francisco, CA (US)

(72) Inventors: Andrew J. Garner, IV, State Road, NC (US); Chris Theodore Kalaboukis, San Jose, CA (US); Rameshchandra Bhaskar Ketharaju, Hyderabad (IN); Joon Maeng, Newcastle, WA (US); Ramanathan Ramanathan, Bellevue, WA (US); Abhijit Rao, Irvine, CA (US); Andres J. Saenz, Cape Coral, FL (US)

(21) Appl. No.: 17/542,212

(22) Filed: Dec. 3, 2021

(51) Int. Cl. G06F 21/60; G06F 21/62

(52) U.S. Cl. CPC G06F 21/606; G06F 21/6218; G06F 2221/2141

(57) ABSTRACT

Techniques are described for distributed storage and retrieval of data by a defined computing system that includes a plurality of computing devices arranged in a network topology. The computing system stores two or more data blocks of a data set across two or more computing devices of the computing system. Each data block comprises at least one fragment of the data set and metadata including a data set identifier. The storage locations of the data blocks are determined based on messages exchanged among the plurality of computing devices, and may only be known by the computing devices within the computing system. After receipt of a request to access the data set, the two or more computing devices retrieve the two or more data blocks based on the data set identifier, and the computing system sends the two or more data blocks to a requesting device external to the computing system.

### TECHNICAL FIELD

The disclosure relates to secure storage of data on computing devices.

### BACKGROUND

Computing devices, such as servers that store information, are difficult to secure. In particular, computing devices and/or servers accessible through a network are vulnerable to hacking, manipulation, and/or unauthorized access. Even where only a small amount of confidential information is compromised or only portions of files stored on a network are obtained by an unauthorized user or hacker, such security failures can have far-reaching and detrimental business, personal, financial, and privacy effects.

### SUMMARY

In general, this disclosure describes techniques for distributed storage and retrieval of data by a defined computing system that includes a plurality of computing devices arranged in a network topology. The computing system stores two or more data blocks of a data set across two or more computing devices of the computing system. Each data block comprises at least one fragment of the data set and metadata including a data set identifier and instructions for reassembling the data set from the two or more data blocks. The storage locations of the two or more data blocks within the computing system (e.g., addresses of the two or more computing devices) are determined based on messages exchanged among the plurality of computing devices of the computing system. In this way, only the computing devices within the defined computing system may know the storage locations of the data blocks. In addition, within the computing system, the storage locations of the data blocks may not be stored or maintained in a centralized manner. The data storage techniques, therefore, provide a high level of security by preventing or limiting unauthorized access to the data set, or, at least, limiting access to the complete data set should an unauthorized user gain access to some of the data blocks that compose the data set.

After storage of the data blocks, the computing system receives a request to access the data set from a requesting device external to the computing system, where the request at least includes the data set identifier for the data set. After receipt of the request, each computing device of the two or more computing devices retrieves a respective data block of the two or more data blocks based on the data set identifier. The computing system then sends the two or more data blocks of the data set to the requesting device. In one example, the request to access the data set may be included in a message that is broadcast to all computing devices of the computing system. The broadcast message may provide a further layer of security by enabling each computing device within the computing system to look up the data set identifier and retrieve any corresponding data blocks without the computing system needing to determine the storage locations of the data blocks associated with the data set identifier. In another example, the request to access the data may be included in a publish-subscribe message in which the requesting device comprises a publisher of the message to a topic associated with the data set identifier and at least the two or more computing devices comprise subscribers to the topic associated with the data set identifier. The publish-subscribe message may also provide a further layer of security by enabling each computing device within the computing system that subscribes to the topic associated with the data set identifier to lookup the data set identifier and retrieve any corresponding data blocks without the computing system needing to determine the storage locations of the data blocks associated with the data set identifier. In some examples, the requesting device may comprise a virtual instance hosted on a computing device external to the computing system that is instantiated for the retrieval of the data blocks from the computing system, and terminated after receipt of the data blocks and/or reassembly of the data set from the data blocks.

In one example, the disclosure is directed to a method comprising storing, by a computing system including a plurality of computing devices arranged in a network topology, two or more data blocks of a data set across two or more computing devices of the plurality of computing devices, wherein each data block of the two or more data blocks comprises at least one fragment of two or more fragments of the data set and metadata including a data set identifier and instructions for reassembling the data set from the two or more data blocks, and wherein storing the two or more data block across the two or more computing devices comprises determining the two or more computing devices of the plurality of computing devices in which to store the two or more data blocks based on messages exchanged among the plurality of computing devices, and storing, by each computing device of the two or more computing devices, a respective data block of the two or more data blocks in a data store of the computing device. The method also comprises, after receipt of a request to access the data set including the data set identifier from a requesting device external to the computing system, retrieving, by each computing device of the two or more computing devices, the respective data block from the data store of the computing device based on the data set identifier; and sending, by the computing system, the two or more data blocks of the data set to the requesting device external to the computing system.

In another example, the disclosure is directed to a computing system including a plurality of computing devices arranged in a network topology, the computing system comprising processing circuitry, and at least one storage device that stores instructions. When the instructions are executed, the instructions cause the processing circuitry to store two or more data blocks of a data set across two or more computing devices of the plurality of computing devices, wherein each data block of the two or more data blocks comprises at least one fragment of two or more fragments of the data set and metadata including a data set identifier and instructions for reassembling the data set from the two or more data blocks, and wherein to store the two or more data block across the two or more computing devices, the processing circuitry is configured to determine the two or more computing devices of the plurality of computing devices in which to store the two or more data blocks based on messages exchanged among the plurality of computing devices, and store, by each computing device of the two or more computing devices, a respective data block of the two or more data blocks in a data store of the computing device. When executed, the instructions also cause the processing circuitry to, after receipt of a request to access the data set including the data set identifier, retrieve, by each computing device of the two or more computing devices, the respective data block from the data store of the computing device based on the data set identifier from a requesting device external to the computing system; and send the two or more data blocks of the data set to the requesting device external to the computing system.

In a further example, the disclosure is directed to a computer-readable medium comprising instructions that, when executed, cause processing circuitry of a computing system including a plurality of computing devices arranged in a network topology to store two or more data blocks of a data set across two or more computing devices of the plurality of computing devices, wherein each data block of the two or more data blocks comprises at least one fragment of two or more fragments of the data set and metadata including a data set identifier and instructions for reassembling the data set from the two or more data blocks, and wherein the instructions to store the two or more data block across the two or more computing devices cause the processing circuitry to determine the two or more computing devices of the plurality of computing devices in which to store the two or more data blocks based on messages exchanged among the plurality of computing devices, and store, by each computing device of the two or more computing devices, a respective data block of the two or more data blocks in a data store of the computing device. The instructions, when executed, also cause the processing circuitry to, after receipt of a request to access the data set including the data set identifier from a requesting device external to the computing system, retrieve, by each computing device of the two or more computing devices, the respective data block from the data store of the computing device based on the data set identifier; and send the two or more data blocks of the data set to the requesting device external to the computing system.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example network system with a computing system including a plurality of computing devices configured to securely store data sets in a distributed fashion, in accordance with one or more aspects of the present disclosure.

FIG. 2 is a block diagram illustrating an example of computing device of a plurality of computing devices within a computing system configured to securely store a data block of a data set, in accordance with the techniques of this disclosure.

FIG. 3 is a block diagram illustrating an example user device having locally stored data sets and an example monitor device configured to facilitate distributed storage and retrieval of the data sets with a computing system, in accordance with the techniques of this disclosure.

FIG. 4 is a flowchart illustrating an example operation of a computing system including a plurality of computing devices arranged in a network topology configured to store data blocks of a data set in a distributed fashion across the computing devices, in accordance with the techniques of this disclosure.

### DETAILED DESCRIPTION

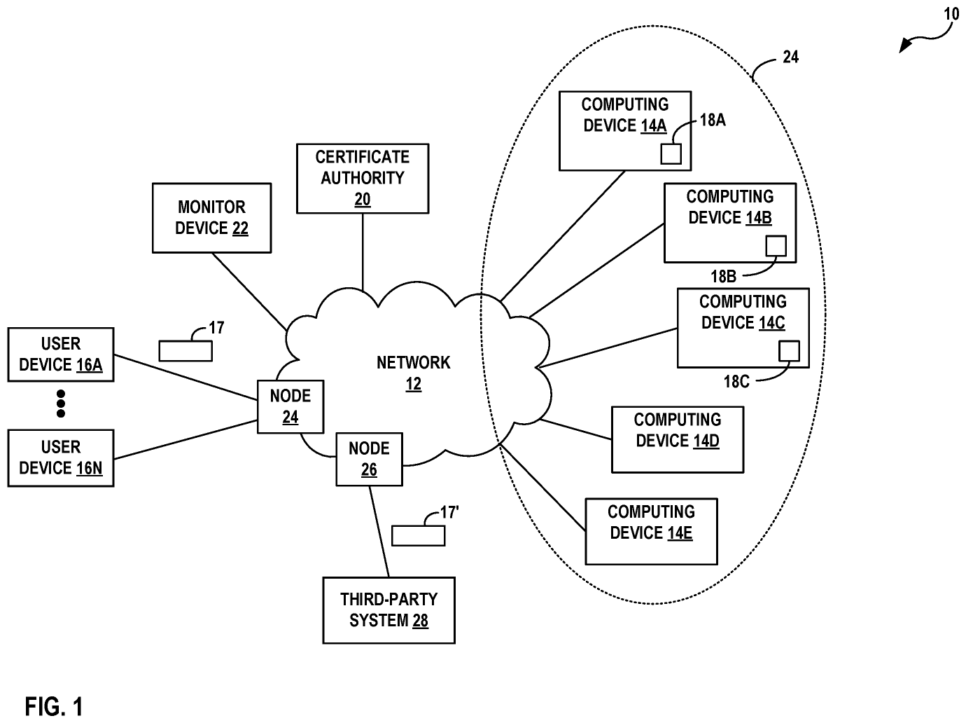

FIG. 1 is a block diagram illustrating an example network system 10 with a defined computing system 24 including a plurality of computing devices configured to securely store data sets in a distributed fashion, in accordance with one or more aspects of the present disclosure. FIG. 1 illustrates one example implementation of network system 10. Other implementations of network system 10 may be appropriate in other instances, and may include a subset of the components included in the example of FIG. 1 and/or may include additional components not shown in FIG. 1.

In the example of FIG. 1, network system 10 includes computing system 24 including computing devices 14A-14E (collectively, “computing devices 14”) arranged in a network topology and in communication with each other via network 12. Computing devices 14 may also communicate with certificate authority 20 and monitor device 22 over network 12. In some examples, computing devices 14 may further communicate directly with user devices 16A-16N (collectively, “user devices 16”) via access node 24 and/or third-party system 28 via access node 26 over network 12.

Network 12 may include or represent any public or private communications network or other network. For instance, network 12 may be a cellular, Wi-Fi®, ZigBee, Bluetooth, Near-Field Communication (NFC), satellite, enterprise, service provider, and/or other type of network enabling transfer of transmitting data between computing systems, servers, and computing devices. One or more of client devices, server devices, or other devices may transmit and receive data, commands, control signals, and/or other information across network 12 using any suitable communication techniques. Network 12 may include one or more network hubs, network switches, network routers, satellite dishes, or any other network equipment. Such devices or components may be operatively inter-coupled, thereby providing for the exchange of information between computers, devices, or other components (e.g., between one or more client devices or systems and one or more server devices or systems). Each of the devices or systems illustrated in FIG. 1 may be operatively coupled to network 12 using one or more network links. The links coupling such devices or systems to network 12 may be Ethernet, Asynchronous Transfer Mode (ATM) or other types of network connections, and such connections may be wireless and/or wired connections. One or more of the devices or systems illustrated in FIG. 1 or otherwise on network 12 illustrated in FIG. 1 may be in a remote location relative to one or more other illustrated devices or systems. In some examples, network 12 may be the Internet. Further, although illustrated as a single entity, network 12 may comprise a combination of multiple networks.

Each of user devices 16 may be implemented as any suitable computing device, such as a mobile, non-mobile, wearable, and/or non-wearable computing device. One or more of user devices 16 may represent a desktop computing device, a laptop or notebook computing device, a mobile computing device (e.g., a smart phone or a tablet). In other examples, one or more of computing devices 16 may include a computerized watch, a computerized glove or gloves, a personal digital assistant, a virtual assistant, a gaming system, a media player, an e-book reader, a television or television platform, a device implanted in a human body, a virtual device, an electrical transmitter, a bicycle, automobile, driverless automobile, or navigation, information and/or entertainment system for a bicycle, automobile or other vehicle, or any other type of wearable, non-wearable, mobile, or non-mobile computing device that may perform operations in accordance with one or more aspects of the present disclosure.

One or more of user devices 16 may operate as a computing device that enables a user to interact with, browse, and/or use information or resources available over a network (e.g., network 12). For instance, one or more of user devices 16 may, at the direction of a user, access or browse for information stored on other devices (e.g., computing devices 14 of computing system 24 or third party system 28), communicate with others, perform calculations, analyze data, process a user's personal communications, control other devices, perform a physical task or cause one to be performed, and access other information or resources. One or more of user devices 16 may pair with and/or communicate with other devices, and may send control signals to other devices or systems.

Third-party system 28 may be implemented as any suitable computing system, such as one or more server computers, workstations, mainframes, appliances, cloud computing systems, and/or other computing system that may be capable of performing functions described in accordance with one or more aspects of the present disclosure. In some examples, third-party system 28 represent a public or private cloud computing system, server farm, or server cluster (or portion thereof) that provides services to client devices and other devices or systems. Third-party system 28 may comprise a customer service portal that performs customer authentication and/or authorization functions prior to permitting access to customer account information. In some examples, third-party system 28 may request customer credentials or customer profiles from user devices 16 and/or computing system 24.

User device 16A, for example, may access network 12 via access node 24 to request storage and/or retrieval of data set 17 or portions of data set 17 stored by computing system 24. Similarly, third-party system 28 may access network 12 via access node 26 to request retrieval of data set 17 or portions of data set 17 stored by computing system 24. Data set 17 may be any type of file (e.g., a word processing document, an audio file, a video file, a spreadsheet, a configuration file, an executable file, etc.) or any set of data files. In the example of FIG. 1, and as further described below, data set 17 may be created and/or maintained by user device 16A and stored in a distributed fashion across computing devices 14 of computing system 24. Data set 17 may later be reassembled for use by third-party system 28 (e.g., as data set 17′), maintenance by user device 16A, or presentation at one or more of user devices 16.

Computing devices 14 within defined computing system 24 may be implemented as any suitable computing system, such as one or more server computers, desktop computers, laptop computers, mainframes, appliances, cloud computing systems, and/or other computing systems that may be capable of sending and receiving information both to and from a network, such as network 12. In some examples, computing system 24 represents a public or private cloud computing system, server farm, or server cluster (or portion thereof) that provides services to client devices and other devices or systems. In some examples, one or more of computing devices 14 may comprise one or more physical or virtual components. In various examples, each of computing devices 14 may comprise a physical entity or machine (e.g., a computing device, a computer server, a quantum computer, a desktop computer, a tablet computer, a laptop computer, smartphone, etc.) or a virtual entity or machine (e.g., a virtual machine, application software in a computing machine, application software in a cloud computing system, etc.).

In accordance with the disclosed techniques, computing system 24 securely stores two or more data blocks 18A-18C (collectively, “data blocks 18”) of data set 17 across two or more of computing devices 14 (e.g., computing devices 14A-14C, respectively) of computing system 24 in a distributed fashion. Furthermore, in response to a retrieval request, computing system 24 may securely retrieve data blocks 18A-18C of data set 17 from computing devices 14A-14C. In some examples, client devices (e.g., user devices 16 and/or third-party system 28) may communicate with computing devices 14 through monitor device 22 and over network 12 to access data blocks 18 of data set 17 stored across computing devices 14 of computing system 24 in a distributed fashion. In some examples, user devices 16 and/or third-party system 28 may access computing devices 14 of computing system 24 directly over network 12.

Monitor device 22 may be implemented as any suitable computing system, such as one or more server computers, workstations, mainframes, appliances, cloud computing systems, and/or other computing system that may be capable of performing functions described in accordance with one or more aspects of the present disclosure. In some examples, monitor device 22 represent a public or private cloud computing system, server farm, or server cluster (or portion thereof) that provides services to client devices and other devices or systems. Monitor device 22 may perform functions relating to the secure storage of one or more data sets and/or data blocks of data sets. In some examples, monitor device 22 may facilitate storage and retrieval of data blocks of data sets with computing system 24. Monitor device 22 may manage storage requests and retrieval requests from user devices 16 and/or third-party system 28. More specifically, monitor device 22 may authenticate and/or authorize access by user devices 16 and/or third-party system 28 to data sets stored across computing devices 14 of computing system 24. Monitor device 22 may further perform functions related to splitting data sets into multiple fragments and generating data blocks for distributed storage across computing system 24, including optionally encrypting the fragments within the data blocks. Monitor device 22 may also perform functions related to reassembling data sets from data blocks retrieved from computing system 24.

Data blocks 18 of data set 17 may include basic storage units for storing at least one fragment of data set 17, e.g., at least a portion of a file or at least one file of a set of data files, at computing devices 14 of computing system 24. Each of data blocks 18 may comprise a payload including the at least one fragment of data set 17 and metadata including a data set identifier of data set 17 (e.g., a unique key or other numeric or alpha-numeric identifier associated with data set 17) and instructions for reassembling data set 17 from the two or more data blocks 18. In some examples, for each of data blocks 18, the at least one fragment of data set 17 is encrypted with an encryption key, and the metadata of the respective data block includes the encryption key used to encrypt the at least one fragment included in the payload of the respective data block.

In general, computing devices and/or servers accessible through a network are vulnerable to hacking, manipulation, and/or unauthorized access. Such unauthorized access may be particularly detrimental in scenarios where data sets or files are stored in a single location within a particular computing device or server. Additional security factors, such as multi-factor authenticated access, encryption, and/or distributed storage of data sets or files in multiple locations across two or more computing devices or servers may provide additional layers of security. One example of a multifaceted security scheme for secure data storage is described in U.S. Pat. No. 10,430,350, issued Oct. 1, 2019, the contents of which are incorporated herein by reference. However, even securely stored data sets or files may still be vulnerable to unauthorized access as long the additional security factors are known to the customer or another person, e.g., the authentication factors, encryption keys, and/or storage locations of the data sets or files.

According to the disclosed techniques, computing system 24 provides distributed storage and retrieval of data blocks 18 of data set 17 across the plurality of computing devices 14 arranged in a network topology such that only computing devices 16 within computing system 24 know the storage locations of data blocks 18. In accordance with the disclosed techniques, the storage locations of the two or more data blocks 18 within computing system 24 are determined based on messages exchanged among the plurality of computing devices 14 of computing system 24, i.e., machine-to-machine communication. In this way, the storage location information, e.g., addresses of computing devices 14A, 14B, 14C, for the two or more data blocks 18 is may only be known by the plurality of computing devices 14 of computing system 24 and not known by any computing devices external to computing system 24 (e.g., monitor device 22, user devices 16, third-party system 28, or any other unauthorized user). In addition, even within computing system 24, the storage locations of data blocks 18 may not be stored or maintained in a centralized manner. As such, it would be difficult, if not impossible, for an unauthorized user to determine the locations of data blocks 18 in order to gain access to all or even a portion of data set 17.

The data storage techniques disclosed herein, therefore, provide a high level of security by preventing, limiting, or otherwise insulating the data from unauthorized access from hackers, rogue actors, and unauthorized users. By insulating data from unauthorized access, computing system 24 may prevent modification or corruption of the data. Accordingly, as a result of insulating data from unauthorized access, computing devices within network system 10, e.g., user devices 16 and/or third-party system 28, are more likely to operate on valid data, and, as a result, more accurately process tasks requested by users of network system 10. Therefore, aspects of this disclosure may improve the function of network system 10, computing system 24, user devices 16 and/or third-party system 28.

In one example, user device 16A may request that information generated at user device 16A be stored securely. For instance, in the example of FIG. 1, user device 16A generates, as a result of user input, data set 17. User device 16A determines, also as a result of user input, that data set 17 is to be stored securely. User device 16A issues to monitor device 22, via access node 24 and network 12, a request to store data set 17 securely. In some examples, user device 16A may execute a storage application to access the services provided by monitor device 22, such as security, data set fragmentation and reassembly, encryption, and distributed storage facilitation services.

Monitor device 22 may determine how data set 17 is to be stored. For instance, monitor device 22 may receive the request from user device 16A and verify the authenticity of the user at user device 16A and/or permissions associated with user device 16A. Monitor device 22 may communicate with certificate authority 20 over network 12 to access or generate one or more encryption keys for use in securely storing fragments of data set 17. Monitor device 22 may split or fracture data set 17 into multiple fragments. In some examples, monitor device 22 encrypts each fragment using an encryption key of the one or more encryption keys associated with the data set identifier of data set 17. Monitor device 22 may generate two or more data blocks 18 for data set 17, where each of the data blocks 18 includes at least one fragment of data set 17 and metadata including a data set identifier of data set 17 and instructions for reassembling the data set 17 from the two or more data blocks 18. Monitor device 22 may then facilitate storage of data blocks 18 across computing devices 14 of computing system 24 in a distributed fashion. In some examples, monitor device 22 may transmit data blocks 18 directly to computing system 24 for distributed storage, without further interaction with user device 16A. In other examples, user device 16A may perform some or all of the functions and/or operations attributed above to monitor device 22.

In the above example, data blocks 18 are generated specifically for distributed storage of data set 17 in computing system 24 upon request from a user of user device 16A. In other examples, the two or more computing devices 14A-14C may respectively cache data blocks 18A-18C of data set 17 during one or more interactions with computing devices external to computing system 24, e.g., access node 24, access node 26, user devices 16, and/or third-party system 28. Computing devices 14 may be configured to cache certain types of data in order to provide distributed storage with or without an explicit request for such storage from users of user devices 16. In either example, computing system 24 stores the two or more data blocks 18 of data set 17 across two or more computing devices 14A-14C of computing system 24. In the illustrated example of FIG. 1, data set 17 is stored as three data blocks: data block 18A at computing device 14A, data block 18B at computing device 14B, and data block 18C at computing device 14C.

In order to store data blocks 18 in a distributed fashion across computing devices 14, computing system 24 may determine the two or more computing devices 14A, 14B, 14C in which to store the two or more data blocks 18 based on messages exchanged among the plurality of computing devices 14 (e.g., machine-to-machine communication). In some examples, each of computing devices 14 may exchange capability information that indicates data storage capacity and/or physical location within the network topology of computing system 24 for the respective computing device. For example, computing devices 14 may collectively determine to store data blocks 18 in computing devices 14A, 14B, 14C based on indicates that each of those computing device has sufficient storage for one of data blocks 18 and that at least one of those computing devices is located within a same geographic region as one or more end-users of reassembled data set 17′, e.g., third-party system 28 or one of user devices 16, to enable high-speed access to reassembled data set 17′ when requested. Each computing device of the two or more computing devices 14A, 14B, 14C may store a respective data block 18A, 18B, 18C in a data store of the computing device. For example, each computing device 14A, 14B, 14C may store the respective data block 18A, 18B, 18C in a record within the data store of the computing device, and create an index to the record with the data set identifier included in the metadata of the respective data block as an index key.

As discussed above, the storage location information, e.g., addresses of computing devices 14A, 14B, 14C, for the two or more data blocks 18 may be used as an additional security factor to access data set 17 as a whole. Unlike conventional distributed storage techniques, the storage location information of data blocks 18 may only be known by computing devices 14 of computing system 24 and not known by any computing devices external to computing system 24. In addition, within computing system 24, the storage location information of data blocks 18 may not be stored or maintained in a centralized manner.

In one example, one of computing devices 14, e.g., computing device 14A, may securely record the storage location information for the two or more data blocks 18 in a distributed ledger or blockchain provided by or available to computing system 24. In this example, computing device 14A, for example, communicates with certificate authority 20 over network 12 to access or generate one or more encryption keys for use in securely storing the storage location information of data blocks 18 of data set 17. Computing device 14A may encrypt the addresses of the two or more computing devices 14A, 14B, 14C with at least one encryption key of the encryption keys associated with the data set identifier of data set 17, and record the encrypted addresses of the two or more computing devices 14A, 14B, 14C in at least one block of the blockchain provided by or available to computing system 24.

In accordance with this example, the data storing techniques may provide a high level of security in which two key pairs are used in the distributed storage of data set 17—one for encryption of the fragments within each of data blocks 18 and one for the storage location information of data blocks 18 within computing system 24. In some examples, certificate authority 20 may generate multiple key pairs. A first key pair may comprise a symmetric key for encryption of one or more of the fragments of data set 17. The second key pair may comprise a public/private key pair used for encryption of one or more of the addresses of the computing devices 14A, 14B, 14C at which respective data blocks 18A, 18B, 18C are stored. In this way, multiple keys are needed to access data blocks 18 and to access the fragments from data blocks 18 for reassembly into data set 17′ for use of the data set as a whole. In some examples, once data blocks 18 are accessed, one or more of the key pairs may become invalid and a new set of keys may be generated with certificate authority 20. In some examples, once data blocks 18 are accessed, computing system 24 may determine a different set of two or more computing devices 14 in which to store data blocks 18. In some further examples, once data blocks 18 are accessed, monitor device 22 may reassemble data set 17′ and then fragment data set 17′ in a different manner for distributed storage across computing system 24.

In some examples, Post Quantum Cryptography (PQC) methods may be used for encrypting both data blocks 18 and the storage location information of data blocks 18. In these examples, monitor device 22 and/or computing devices 14 may be configured to use PQC-based migration techniques. In one such technique, there may be two levels of encryption: (1) a classical encryption on the plaintext data block and/or storage addresses, and (2) a PQC encryption on the Ciphertext of the previously encrypted data. During decryption, monitor device 22 and/or computing devices 14 may first decrypt using PQC techniques and then follow with classical decryption.

After storage of data blocks 18, computing system 24 may subsequently receive a request to access data set 17 including the data set identifier for data set 17 from a requesting device external to computing system 24. In some examples, monitor device 22 may be the requesting device and may facilitate the retrieval request initiated by one of user devices 16 or third-party system 28. As one specific example, in response to the initiation of a retrieval request by one of user devices 16 or third-party system 28, monitor device 22 may verify the authenticity of the user at the one of user devices 16 and/or permissions associated with the one of user devices 16 or third-party system 28. Monitor device 22 may then instantiate a virtual instance to operate as the requesting device for the retrieval of data set 17 from the computing system 24. After receipt of data blocks 18 of data set 17 and/or reassembly of the data set 17′ from the data blocks 18, monitor device 22 may terminate the virtual instance.

In response to the retrieval request for data set 17 from the requesting device, each computing device 14A, 14B, 14C retrieves the respective data block 18A, 18B, 18C from the data store of the computing device based on the data set identifier. For example, each of computing devices 14A, 14B, 14C may retrieve the respective data block 18A, 18B, 18C from the record within the data store of the computing device using the data set identifier from the request as the index key of the record within the data store. Computing system 24 then sends the two or more data blocks 18 of data set 17 to the requesting device.

In one scenario, monitor device 22 may send the retrieval request including the data set identifier within a broadcast message to all computing devices 14 within computing system 24. In this scenario, each computing device 14 within computing system 24 may look up the data set identifier and retrieve any corresponding data blocks in its data store without computing system 24 needing to determine the storage locations of the data blocks 18 associated with the data set identifier. In the illustrated example of FIG. 1, after receipt of the broadcast message, each of computing devices 14A, 14B, 14C may look up the data set identifier and retrieve respective data blocks 18A, 18B, 18C from the data store of the computing device based on the data set identifier. Continuing the example, after receipt of the broadcast message, each of computing devices 14D, 14E may look up the data set identifier and, upon not locating an index key that matches the data set identifier, the look up fails and no data is retrieved.

In another scenario, monitor device 22 may publish the retrieval request including the data set identifier as a publish-subscribe message to a topic that is associated with the data set identifier. At least computing devices 14A, 14B, 14C that are storing the data blocks 18 associated with the data set identifier may be subscribers to the topic associated with the data set identifier. The subscriber computing devices, e.g., computing devices 14A, 14B, 14C, may determine when to receive the messages published to the topic associated with the data set identifier. For example, the subscriber computing devices may “pull” the messages published to the topic either ad hoc or according to some preset schedule, or the messages published to the topic may “push” to the subscriber computing devices according to preset time windows during which the subscriber devices are listening for messages published to the topic. In this scenario, at least computing device 14A, 14B, 14C within computing system 24 may look up the data set identifier and retrieve any corresponding data blocks in its data store without computing system 24 needing to determine the storage locations of the data blocks 18 associated with the data set identifier. In the illustrated example of FIG. 1, upon receipt of the publish-subscribe message, each of computing devices 14A, 14B, 14C may look up the data set identifier and retrieve respective data blocks 18A, 18B, 18C from the data store of the computing device based on the data set identifier. Continuing the example, computing devices 14D, 14E may not subscribe to the topic associated with the data set identifier and, thus, may not receive the publish-subscribe message including the retrieval request.

In another scenario in which the storage location information is securely recorded in the blockchain, at least one of computing devices 14, e.g., computing device 14A, may receive the request to access data set 17 including the data set identifier from monitor device 22. In response to the retrieval request, computing device 14A may decrypt the addresses of the two or more computing devices 14A, 14B, 14C from the at least one block of the blockchain with at least one decryption key associated with the data set identifier and assigned to the computing device 14A. Computing device 14A may then use the decrypted addresses of the two or more computing devices 14A, 14B, 14C to instruct the two or more computing devices 14A, 14B, 14C to retrieve the two or more data blocks 18.

In either of the above scenarios, in one example, after receiving data blocks 18, each of computing devices 14A, 14B, 14C may then send the respective data blocks 18A, 18B, 18C directly to monitor device 22 as the requesting device. In other examples, in order to preserve the anonymity of the storage locations within computing system 24, each of computing devices 14A, 14B, 14C may send the respective data blocks 18A, 18B, 18C to a designated one of computing devices 14, e.g., computing device 14A, to be packaged and sent to monitor device 22 as the requesting device. After receipt of the retrieved data blocks 18, monitor device 22 may decrypt the fragments within each of data blocks 18 using a decryption key of the one or more encryption keys associated with the data set identifier of data set 17 and/or associated with the encryption key included in the metadata of the respective one of data blocks 18. Monitor device 22 may then reassemble data set 17′ from data blocks 18 based on the instructions included in the metadata of data blocks 18. In some examples, monitor device 22 may send the retrieved data blocks 18 to the one of user devices 16 or third-party systems 28 that initiated the retrieval request. In other examples, monitor device 22 may reassemble data set 17′ from the two or more data blocks 18, and send data set 17′ to the one of user devices 16 or third-party systems 28 that initiated the retrieval request.

In one example use case, data set 17 may be a customer profile generated from data blocks or micro-profiles 18 stored by the two or more computing devices 14A, 14B, 14C of computing system 24. In this example, as computing devices 14 interact with each other to perform certain transactions, each of computing devices 14A, 14B, 14C caches a portion 18A, 18B, 18C of the customer profile information for use in performing the certain transactions. Over time, as similar transactions are repeated, the same computing devices 14A, 14B, 14C may be used and each of the computing devices 14A, 14B, 14C may build and store a respective micro-profile 18A, 18B, 18C for the customer based on the cached data. Computing system 24 may track the frequently-used machines for the particular customer such that, for subsequent transactions, the micro-profiles 18A, 18B, 18C at each of the frequently-used computing devices 14A, 14B, 14C may be autonomously combined to create a full customer profile for use by one of user devices 16 and/or third-party system 28.

In a similar use case, where the same transaction or task is repeatedly requested, the same one of computing devices 14, e.g., computing device 14A, that has cached a data block, e.g., data block 18A, that used for the task may be able to autonomously perform the task based on the cached data block 18A without repeatedly requesting and/or pulling the customer information or parameters from an external database or other source. In the case where an external system, e.g., third-party system 28, is requesting authentication or verification of the customer's identify, two or more of the frequently-used computing devices 14A, 14B, 14C may work together to verify the identity of the customer without requiring customer interaction. More specifically, the two or more computing devices 14A, 14B, 14C may combine their cached data blocks 18A, 18B, 18C to provide the information to third-party system 28 in order to verify the customer's identity. In this way, instead of a human entering a password to verify the customer's identity, the two or more frequently-used computing devices 14A, 14B, 14C may be identified and used to authenticate the customer. In other cases, the two or more computing devices 14A, 14B, 14C may be configured to answer challenge questions used to verify the customer's identity that are not included in the customer profile, e.g., what were the customer's last three transactions. Computing system 24 may use a blockchain or the most frequently-used computing devices 14A, 14B, 14C to identify from which computing devices 14 to retrieve the information to respond to the challenge questions.

In another example use case, data set 17 may be documents or other materials intended to be confidential within a group, such as a family, business, or community. In this example, it may be beneficial to partition the data set 17 into data blocks 18, and distribute data blocks 18 for storage within computing system 24 associated with that group for increased security. For example, computing system 24 may comprise a family network of computing devices 14 used to fence data set 17 within the network topology of computing system 24 such that only members within the family have access to the data set 17. More specifically, only computing devices 14 within computing system 24 would know or track the storage location information of data blocks 18 of data set 17 and, thus, only the computing devices 14 within computing system 24 would be able to fulfill the security factors needed to access the data set 17.

In addition, the data storing techniques described herein may enable large data sets to be stored across plurality of computing devices 14 within computing system 24 without requiring large data storage capacity. For example, each data block 18 of data set 17 may be relatively small compared to data set 17 as a whole and, in some cases, each data block 18 of data set 17 may be stored in cache memory of the respective computing device 14. As one specific example, there may be 100 cameras 14 in a neighborhood topology of computing system 24, and an accident may be visible in image data captured by only seven of the cameras. One or more cameras 14 or other computing devices of computing system 24 may analyze all the camera image data and identify the seven cameras. The seven identified cameras may then combine their images to form a full blown video model of the accident. In some cases, a financial valuation may be established for the data blocks and/or the storage space and each of the computing devices 14 used to store the data blocks (e.g., the seven identified cameras) may receive payment tokens in exchange for storage of the data blocks.

Each of the computing systems illustrated in FIG. 1 (e.g., computing devices 14 of computing system 24, user devices 16, certificate authority 20, monitor device 22, access node 24, access node 26, and third-party system 28) may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such computing devices may perform operations described herein as a result of instructions, stored on a computer-readable storage medium, executing on one or more processors. The instructions may be in the form of software stored on one or more local or remote computer readable storage devices. In other examples, one or more of such computing devices may perform operations using hardware, firmware, or a mixture of hardware, software, and firmware residing in and/or executing at each of such computing devices. Furthermore, one or more of such computing devices may comprise one or more physical or virtual components. For instance, in various examples, a device, system, or other entity shown in FIG. 1 may comprise a physical entity or machine (e.g., a computing device, a computer server, a quantum computer, a desktop computer, a tablet computer, a laptop computer, smartphone, etc.) and/or virtual entity or machine (e.g., virtual machine, application software in a computing machine, cloud computing system, etc.).

Although functions and operations described in connection with network system 10 of FIG. 1 may be illustrated as being performed across multiple devices in FIG. 1, in other examples, the features and techniques attributed to one or more devices in FIG. 1 may be performed internally, by local components of one or more of such devices. Similarly, one or more of such devices may include certain components and perform various techniques that may otherwise be attributed in the description herein to one or more other devices. Further, certain operations, techniques, features, and/or functions may be described in connection with FIG. 1 or otherwise as performed by specific components, devices, and/or modules. In other examples, such operations, techniques, features, and/or functions may be performed by other components, devices, or modules. Accordingly, some operations, techniques, features, and/or functions attributed to one or more components, devices, or modules may be properly attributed to other components, devices, and/or modules, even if not specifically described herein in such a manner.

In particular, although user devices 16 and computing devices 14 are described in connection with FIG. 1 (and elsewhere) as performing specific types of functions (e.g., user devices 16 as client devices, computing devices 14 as storage devices), in other examples, user devices 16 and computing devices 14 may perform other functions. Computing devices 14 need not be dedicated servers, and user devices 16 need not be dedicated client devices. For instance, one or more of user devices 16 may perform storage operations that are generally attributed herein to computing devices 14. Similarly, one or more of computing devices 14 may perform data set maintenance and/or client functions that are generally attributed herein to user devices 16. In some examples, user device 16 and computing devices 14 may be interchangeable. Further, operations described herein as being performed by monitor device 22 may be performed by other systems, computing devices, components, or modules illustrated in FIG. 1 or elsewhere.

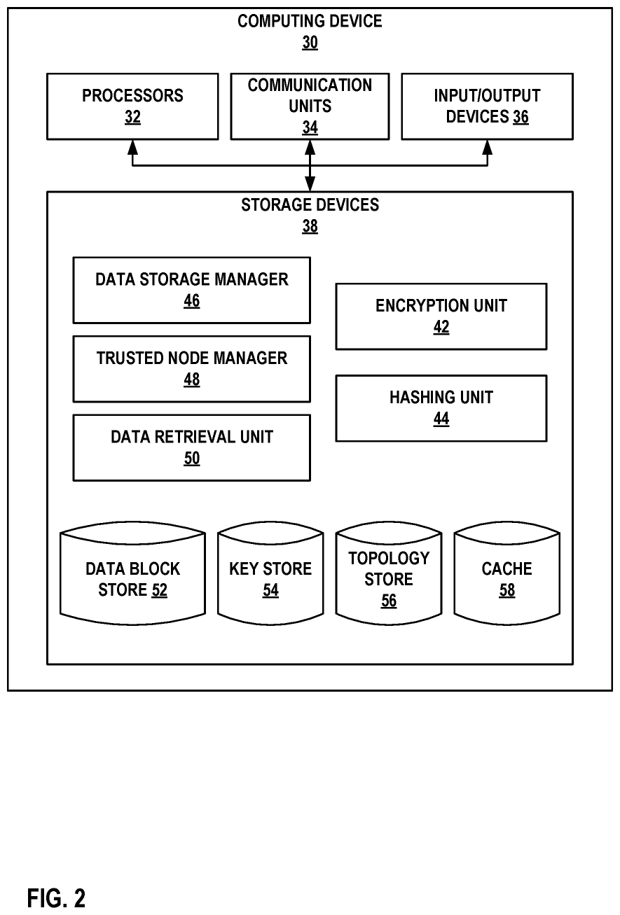

FIG. 2 is a block diagram illustrating an example of computing device 30 of a plurality of computing devices within a computing system, e.g., computing system 24 of FIG. 1, configured to securely store a data block of a data set, in accordance with the techniques of this disclosure. Computing device 30 may operate substantially similar to any of computing devices 14 of FIG. 1. The architecture of computing device 30 illustrated in FIG. 2 is shown for exemplary purposes only. Computing device 30 should not be limited to the illustrated example architecture. In other examples, computing device 30 may be configured in a variety of ways.

Computing device 30 may be implemented within any suitable computing system, such as one or more server computers, workstations, mainframes, appliances, cloud computing systems, and/or other computing systems that may be capable of performing operations and/or functions described in accordance with one or more aspects of the present disclosure. In some examples, computing device 30 may comprise a server within a data center, cloud computing system, server farm, and/or server cluster (or portion thereof) that provides file and/or data block storage services to client devices (e.g., user devices 16 or third-party system 28 from FIG. 1) and other devices or systems. For example, client devices may communicate with computing device 30 to access services provided by one or more modules of computing device 30. Computing device 30 may provide, for instance, data block storage services in response to input received from one or more client devices.

In the example of FIG. 2, computing device 30 may include one or more processors 32, one or more communication units 34, one or more input/output devices 36, and one or more storage devices 38. Storage devices 38 may include data storage manager 46, trusted node manager 48, data retrieval unit 50, encryption unit 42, hashing unit 44, data block store 52, encryption key store 54, topology store 56, and cache 58. One or more of the devices, modules, storage areas, or other components of computing device 30 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) is provide power to one or more components of computing device 30. In some examples, the power source may receive power from the primary alternative current (AC) power supply in a commercial building or data center, where some or all of an enterprise network may reside. In other examples, the power source may be or may include a battery.

One or more processors 32 of computing device 30 may implement functionality and/or execute instructions associated with computing device 30 associated with one or more modules illustrated herein and/or described below. One or more processors 32 may be, may be part of, and/or may include processing circuitry that performs operations in accordance with one or more aspects of the present disclosure. Examples of processors 32 include microprocessors, application processors, display controllers, auxiliary processors, one or more sensor hubs, and any other hardware configured to function as a processor, a processing unit, or a processing device. Computing device 30 may use one or more processors 32 to perform operations in accordance with one or more aspects of the present disclosure using software, hardware, firmware, or a mixture of hardware, software, and firmware residing in and/or executing at computing device 30.

One or more communication units 34 of computing device 30 may communicate with devices external to computing device 30 by transmitting and/or receiving data, and may operate, in some respects, as both an input device and an output device. In some examples, communication units 34 may communicate with other devices over a network. In other examples, communication units 34 may send and/or receive radio signals on a radio network such as a cellular radio network. In other examples, communication units 34 of computing device 30 may transmit and/or receive satellite signals on a satellite network such as a GPS network. Examples of communication units 32 include a network interface card (e.g., such as an Ethernet card), an optical transceiver, a radio frequency transceiver, a GPS receiver, or any other type of device that can send and/or receive information. Other examples of communication units 34 may include devices capable of communicating over Bluetooth®, GPS, near-field communication (NFC), ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input/output devices 36 may represent any input or output devices of computing device 30 not otherwise separately described herein. One or more input/output devices 36 may generate, receive, and/or process input from any type of device capable of detecting input from a human or machine. One or more input/output devices 34 may generate, present, and/or process output through any type of device capable of producing output.

One or more storage devices 38 within computing device 30 may store information for processing during operation of computing device 30. Storage devices 38 may store program instructions and/or data associated with one or more of the modules described in accordance with one or more aspects of this disclosure. One or more processors 32 and one or more storage devices 38 may provide an operating environment or platform for such modules, which may be implemented as software, but may in some examples include any combination of hardware, firmware, and software. One or more processors 32 may execute instructions and one or more storage devices 38 may store instructions and/or data of one or more modules. The combination of processors 32 and storage devices 38 may retrieve, store, and/or execute the instructions and/or data of one or more applications, modules, or software. Processors 32 and/or storage devices 38 may also be operably coupled to one or more other software and/or hardware components, including, but not limited to, one or more of the components of computing device 30 and/or one or more devices or systems illustrated as being connected to computing device 30.

In some examples, one or more storage devices 38 are temporary memories, meaning that a primary purpose of the one or more storage devices is not long-term storage. Storage devices 38 of computing device 30 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 38, in some examples, also include one or more computer-readable storage media. Storage devices 38 may be configured to store larger amounts of information than volatile memory. Storage devices 38 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

In accordance with the disclosed techniques, trusted node manager 48 of computing device 30 is configured to discover and maintain the one or more other computing devices arranged in a network topology within a defined computing system, e.g., computing devices 14 of computing system 24 from FIG. 1. For example, trusted node manager 48 may exchange “hello” messages via communication units 34 with the other computing devices to determine the network topology of the defined computing system. Trusted node manager 48 may then store a current version of the network topology of the defined computing system in topology store 56. Trusted node manager 48 may continually or periodically update topology store 56 as the network topology of computing devices within the defined computing system changes.

Data storage manager 46 of computing device 30 is configured to store at least one data block of a data set that is collectively stored across the other computing devices within the network topology of the computing system. In some examples, data store manager 46 may receive the data block of the data set from an entity external to the computing system, e.g., monitor device 22, one of user devices 16, or third-party system 28 from FIG. 1. In other examples, computing device 30 may cache data during interactions with other computing devices to perform certain transactions. In these examples, data store manger 46 may receive the data block of the data set from a record within cache 58.

Data store manager 46 may exchange messages via communication unit 34 with the one or more other computing devices within the computing system in order to exchange capability information with the other computing devices. In one example, the capability information for computing device 30 may include a data storage capacity, e.g., a number of available bytes, of data block store 52 or another database associated with computing device 30. In another example, the capability information for computing device 30 may include a physical location within the network topology of the computing system relative to one or more external computing systems that may access data sets stored in the computing system. In some scenarios, it may be beneficial to store one or more data blocks of a data set at computing devices that are within a same geographic region as one or more end-users of the data set, e.g., a third-party system or one of user devices, to enable high-speed access to the data blocks and/or the reassembled data set.

Based on the exchanged messages, data storage manager 46 of computing device 30 and the other computing devices within the network topology of the defined computing system may collectively determine two or more computing devices of the computing system in which to store two or more data blocks of the data set. In the example of FIG. 2, computing device 30 is determined to be one of the two or more computing devices to store one data block of the two or more data blocks of the data set based on the capability messages exchanged among the computing devices of the computing system.

Data storage manger 46 may store the respective data block in a record within data block store 53 of computing device 30, and create an index to the record with the data set identifier included in the metadata of the respective data block as an index key. Data retrieval unit 50 of computing device 30 may, after receipt of a request to access the data set including the data set identifier, retrieve the respective data block from the record within data block store 52 using the data set identifier from the request as the index key of the record within data block store 52.

In accordance with the disclosed techniques, the storage location information for the respective data block, e.g., a physical or logical address of computing device 30, may only be known by the plurality of computing devices within the network topology of the defined computing system. In some examples, after determining computing device 30 to store one data block of the data set, data storage manager 46 may simply store the data block without the address of computing device 30 being advertised or recorded within the computing system or external to the computing system. In other examples, computing device 30 or another computing device within the defined computing system may securely record the address of computing device 30 as the storage location information for the respective data block. More specifically, encryption unit 42 of computing device 30 may encrypt the address of computing device 30 with at least one encryption key associated with the data set identifier of the data set. The at least one encryption key may be generated with a certificate authority, e.g., certificate authority 20 from FIG. 1, and stored in encryption key store 54 of computing device 30. In some examples, encryption unit 42 of computing device 30 may use PQC methods to encrypt the data block and/or the address of computing device 30 as the storage location information for the data block. Data storage manger 46 may then record the encrypted address of computing device 30 in a block of a blockchain available to or provided by the defined computing system.

In some examples, prior to storing the respective data block of the data set in data block store 52, hashing unit 44 of computing device 30 or another computing device within the defined computing system calculates a hash value of the two or more data blocks of the data set using a particular hash function. Hashing unit 44 may temporarily record the hash value in cache 58, may store the hash value of the two or more data blocks of the data set along with the respective data block in data block store 52, or may store the hash value in another database associated with computing device 30 or the defined computing system. Subsequently, hashing unit 44 may, after receipt of a request to access the data set including the data set identifier, send the hash value of the two or more data blocks of the data set to a requesting device external to the defined computing system. The requesting device, e.g., monitor device 22, may validate the two or more data blocks of the data set based on the hash value.

Data retrieval unit 50 of computing device 30 may, after receipt of a request to access the data set including the data identifier, retrieve the respective data block from the data block store 52 based on the data set identifier. As described above, data retrieval unit 50 may retrieve the respective data block from a record within data block store 52 using the data set identifier from the request as the index key of the record within data block store 52. Data retrieval unit 50 may receive the request to access the data set from a requesting device external to the defined computing system, e.g., monitor device 22, one of user devices 16, or third-party system 28 from FIG. 1.

In some examples, data retrieval unit 50 may receive the request to access the data set including the data set identifier in a broadcast message from the requesting device that is sent to all the computing devices within the defined computing system. In another example, data retrieval unit 50 may receive the request to access the data set including the data set identifier in a publish-subscribe message that is published, by the requesting device, to a topic associated with the data set identifier. In this example, computing device 30 comprises a subscriber to the topic associated with the data set identifier such that retrieval unit 50 may “pull” messages published to the topic either ad hoc or according to some preset schedule, or the messages published to the topic may “push” to retrieval unit 50 according to preset time windows during which computing device 30 is listening for messages published to the topic. In response to receipt of the retrieval request via broadcast or publish-subscribe messaging, each computing device within the defined computing system that receives the retrieval request, including computing device 30, may perform a look up the data set identifier and retrieve any corresponding data blocks in its data block store without the defined computing system needing to determine the storage locations of the data blocks associated with the data set identifier.

In other examples, data retrieval unit 50 of computing device 30 or another computing device within the defined computing system may receive the request to access the data set including the data set identifier from the requesting device directly. In response, encryption unit 42 of computing device 30 or another computing device within the defined computing system may decrypt the address of computing device 30 from the block of the blockchain as a storage location of the respective block of the data set. More specifically, encryption unit 42 of computing device 30 may decrypt the address of computing device 30 and the addresses of the one or more other computing devices storing data blocks of the data set with at least one decryption key associated with the data set identifier and assigned to computing device 30. The at least one decryption key may be generated with a certificate authority, e.g., certificate authority 20 from FIG. 1, and stored in encryption key store 54 of computing device 30. In some examples, encryption unit 42 of computing device 30 may use PQC methods to decrypt the data block and/or the address of computing device 30 as the storage location information for the data block. Data retrieval unit 50 of computing device 30 or another computing device within the defined computing system may then use the decrypted addresses of the two or more computing devices to instruct the two or more computing devices to retrieve the data blocks of the data set.

Data retrieval unit 50 of computing device 30 or another computing device within the defined computing system may then send at least the respective data block of the data set via commination units 34 to the requesting device external to the defined computing system. In some examples, data retrieval unit 50 of computing device 30 may send the respective data block retrieved from data block store 52 directed to the requesting device. In other examples, data retrieval unit 50 of computing device 30 may send the respective data block retrieved from data block store 52 to a designated computing device within the defined computing system for to be packaged and sent to the requesting device. In still other examples, computing device 30 may be the designed computing device within the defined computing system and may receive the other data blocks of the data set form other computing devices within the defined computing system, package the respective data block retrieved from data block store 52 with the other data blocks of the data set, and send the package to the requesting device.

Although illustrated in FIG. 2 as being included in computing device 30, in other examples, encryption key store 54 and/or topology store 56 may be maintained externally in one or more of a plurality of databases and other storage facilities accessible via a network, e.g., network 12 from FIG. 1. In some examples, key store 54 and/or topology store 56 may be encrypted. The type of encryption, strength of encryption, and encryption channel used to encrypt key store 54 and/or topology store 56 may be configurable by one or more administrators of computing device 30 and other computing devices included in the computing system along with computing device 30.

Modules illustrated in FIG. 2 (e.g., data storage manager 46, trusted node manager 48, data retrieval unit 50, encryption unit 42, hashing unit 44) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

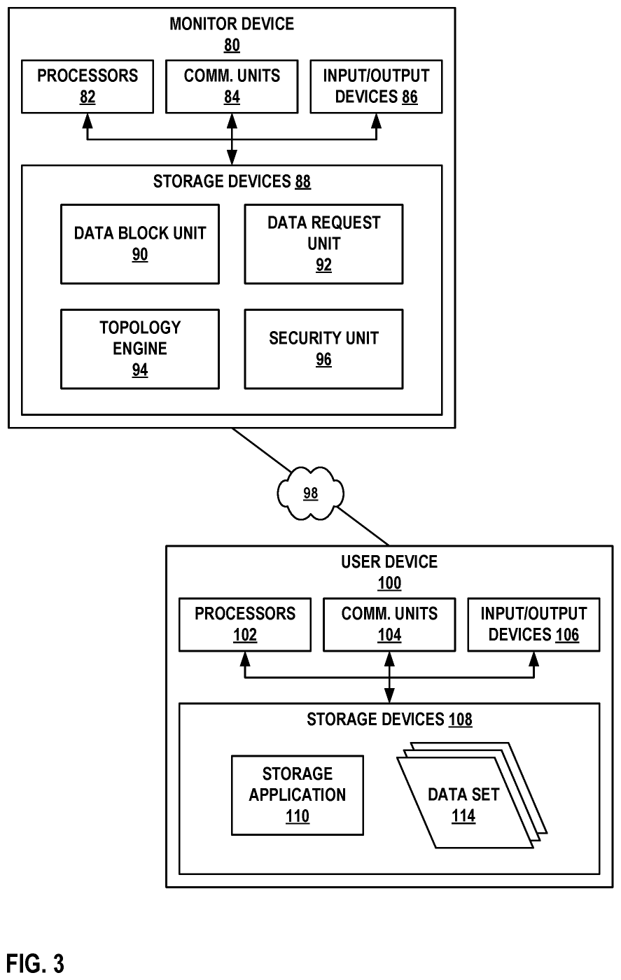

FIG. 3 is a block diagram illustrating an example user device 100 having a locally stored data set 114 and an example monitor device 80 configured to facilitate distributed storage and retrieval of the data sets with a computing system, e.g., computing system 24 of FIG. 1, in accordance with the techniques of this disclosure. Monitor device 80 may operate substantially similar to monitor device 22 of FIG. 1. User device 100 may operate substantially similar to any of user devices 16 of FIG. 1. The architecture of monitor device 80 and of user device 100 illustrated in FIG. 3 are shown for exemplary purposes only. Monitor device 80 and user device 100 should not be limited to the illustrated example architecture. In other examples, each of monitor device 80 and user device 100 may be configured in a variety of ways.

Monitor device 80 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, monitor device 80 may comprise a server within a data center, cloud computing system, server farm, and/or server cluster (or portion thereof) that provides services to client devices and other devices or systems. For example, monitor device 80 may host or provide access to services provided by one or more modules running on monitor device 80. User device 100 may be implemented as any suitable computing device, such as a desktop computer, laptop computer, mobile device, and/or any other computing device that may be capable of performing operations and/or functions described in accordance with one or more aspects of the present disclosure. User device 100 may execute a storage application 110 to access the services provided by one or more modules of monitor device 80 via network 98.

Although monitor device 80 and user device 100 of FIG. 3 are each illustrated as a stand-alone device, in other examples monitor device 80 and/or user device 100 may be implemented in any of a wide variety of ways, and may be implemented using multiple devices and/or systems. In some examples, monitor device 80 and/or user device 100 may be, or may be part of, any component, device, or system that includes a processor or other suitable computing environment for processing information or executing software instructions and that operates in accordance with one or more aspects of the present disclosure. In some examples, monitor device 80 and/or user device 100 may be fully implemented as hardware in one or more devices or logic elements.

In the example of FIG. 3, monitor device 80 may include one or more processors 82, one or more communication units 84, one or more input/output devices 86, and one or more storage devices 88. Storage devices 88 may include data block unit 90, data request unit 92, topology engine 94, and security unit 96. User device 100 may include one or more processors 102, one or more communication units 104, one or more input/output devices 106, and one or more storage devices 108. Storage devices 108 may include storage application 110 and data set 114. In the illustrated example of FIG. 3, monitor device 80 is remotely connected to user device 100 via network 98. In other examples, monitor device 80 may be locally connected to user device 100 via a local network or a physical cable.

One or more of the devices, modules, storage areas, or other components within each of monitor device 80 and user device 100 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) is provide power to one or more components within each of monitor device 80 and user device 100. In some examples, the power source may receive power from the primary alternative current (AC) power supply in a commercial building or data center, where some or all of an enterprise network may reside. In other examples, the power source may be or may include a battery.

One or more processors 82, 102 may implement functionality and/or execute instructions associated with monitor device 80 and user device 100, respectively, associated with one or more modules illustrated herein and/or described below. One or more processors 82, 102 may be, may be part of, and/or may include processing circuitry that performs operations in accordance with one or more aspects of the present disclosure. Examples of processors 82, 102 include microprocessors, application processors, display controllers, auxiliary processors, one or more sensor hubs, and any other hardware configured to function as a processor, a processing unit, or a processing device. Monitor device 80 and user device 100 may respectively use one or more processors 82, 102 to perform operations in accordance with one or more aspects of the present disclosure using software, hardware, firmware, or a mixture of hardware, software, and firmware residing in and/or executing at monitor device 80 and user device 100.

One or more communication units 84, 104 of monitor device 80 and user device 100, respectively, may communicate with devices external to monitor device 80 and user device 100 by transmitting and/or receiving data, and may operate, in some respects, as both an input device and an output device. In some examples, communication units 84, 104 may communicate with other devices over a network. In other examples, communication units 84, 104 may send and/or receive radio signals on a radio network such as a cellular radio network. In other examples, communication units 84, 104 may transmit and/or receive satellite signals on a satellite network such as a GPS network. Examples of communication units 84, 104 include a network interface card (e.g., such as an Ethernet card), an optical transceiver, a radio frequency transceiver, a GPS receiver, or any other type of device that can send and/or receive information. Other examples of communication units 84, 104 may include devices capable of communicating over Bluetooth®, GPS, NFC, ZigBee, and cellular networks (e.g., 3G, 4G, 5G), and Wi-Fi® radios found in mobile devices as well as USB controllers and the like. Such communications may adhere to, implement, or abide by appropriate protocols, including TCP/IP, Ethernet, Bluetooth, NFC, or other technologies or protocols.

One or more input/output devices 86, 106 may represent any input or output devices of monitor device 80 and user device 100, respectively, not otherwise separately described herein. One or more input/output devices 86, 106 may generate, receive, and/or process input from any type of device capable of detecting input from a human or machine. One or more input/output devices 86, 106 may generate, present, and/or process output through any type of device capable of producing output.

One or more storage devices 88, 108 of monitor device 80 and user device 100, respectively, may store information for processing during operation of monitor device 80 and user device 100. Storage devices 88, 108 may store program instructions and/or data associated with one or more of the modules described in accordance with one or more aspects of this disclosure. One or more processors 82, 102 and one or more storage devices 88, 108, respectively, may provide an operating environment or platform for such modules, which may be implemented as software, but may in some examples include any combination of hardware, firmware, and software. One or more processors 82, 102 may execute instructions and one or more storage devices 88, 108, respectively, may store instructions and/or data of one or more modules. The combination of processors 82, 102 and storage devices 88, 108, respectively, may retrieve, store, and/or execute the instructions and/or data of one or more applications, modules, or software. Processors 82, 102 and/or storage devices 88, 108, respectively, may also be operably coupled to one or more other software and/or hardware components, including, but not limited to, one or more of the components of monitor device 80 and user device 100, respectively, and/or one or more devices or systems illustrated as being connected to monitor device 80 and user device 100.

In some examples, one or more storage devices 88, 108 are temporary memories, meaning that a primary purpose of the one or more storage devices is not long-term storage. Storage devices 88, 108 may be configured for short-term storage of information as volatile memory and therefore not retain stored contents if deactivated. Examples of volatile memories include RAM, DRAM, SRAM, and other forms of volatile memories known in the art. Storage devices 88, 108, in some examples, also include one or more computer-readable storage media. Storage devices 88, 108 may be configured to store larger amounts of information than volatile memory. Storage devices 88, 108 may further be configured for long-term storage of information as non-volatile memory space and retain information after activate/off cycles. Examples of non-volatile memories include magnetic hard disks, optical discs, floppy disks, Flash memories, or forms of EPROM or EEPROM memories.

In accordance with the disclosed techniques, user device 100 may maintain data set 114. Data set 114 may be any type of file (e.g., a word processing document, an audio file, a video file, a spreadsheet, a configuration file, an executable file, etc.) or set of files. In the example of FIG. 3, data set 114 may be created as a result of user interactions with input/output devices 106 and stored within storage devices 108 of user device 100. Upon creation, data set 114 is assigned a data set identifier, which is a unique key or other numeric or alpha-numeric identifier associated with data set 114. User device 100 may execute a storage application 110 to access services provided by monitor device 80 via network 98. Storage application 110 and monitor device 80 may provide, for instance, security, data set fragmentation and reassembly, encryption, and distributed storage facilitation services in response to input received from user device 100 via input/output devices 106. In some examples, after storage in a defined computing system, e.g., computing system 24 from FIG. 1, data set 114 may be reassembled and presented at user device 100 via one of a display devices included in input/output devices 106.

In some examples, a user of user device 100 may interact with storage application 110 via one of input/output devices 106 to request secure storage of data set 114. In response, storage application 110 of user device 100 communications with monitor device 80 via communication unit 104 and network 98 to request distributed storage of data set 114 in the defined computing system. In other examples, a user of user device 100 may interact with storage application 110 via one of input/output devices 106 to request retrieval of data set 114 from the defined computing system. In response, storage application 110 of user device 100 communications with monitor device 80 via communication unit 104 and network 98 to initiate a retrieval request for the data blocks of data set 114 from the defined computing system.

After receipt of the request for secure storage of data set 114 and/or the request for retrieval of data set 114, security unit 96 of monitor device 80 may perform functions relating to validating access to monitor device 80 and/or the defined computing system. In some examples, security unit 96 may be configured to authenticate and/or authorize access by user device 100 to the computing devices of the defined computing system prior to processing the received request for either data storage or data retrieval. In other examples, after retrieval of data blocks of data set 114 from the defined computing system, security unit 96 may be configured to calculate a hash value of the retrieved data blocks using a particular hash function. Security unit 96 may compare the hash value to a received hash value included with the data blocks from the defined computing system, and validate whether the retrieved data blocks include the same information as the two or more data blocks of data set 114 original sent to the defined computing system for distributed storage.

In order to facilitate distributed storage of data set 114, data block unit 90 of monitor device 80 may split or fracture data set 114 into multiple fragments. In some examples, data block unit 90 may also encrypt each fragment of data set 114 using an encryption key of one or more encryption keys associated with the data set identifier of data set 114. The one or more encryption keys may be generated with a certificate authority, e.g., certificate authority 20 from FIG. 1, and stored in storage devices 88 of monitor device 80 or an encryption key store or other database associated with monitor device 80. Data block unit 90 may then generate two or more data blocks for data set 114, where each of the data blocks includes at least one fragment of data set 114 and metadata including a data set identifier of data set 114 and instructions for reassembling the data set 114 from the two or more data blocks.

Topology engine 94 of monitor device 80 is configured to discover and maintain the one or more other computing devices arranged in the network topology within the defined computing system, e.g., computing devices 14 of computing system 24 from FIG. 1. For example, topology engine 94 may continually or periodically receive topology information from the one or more of computing devices within the defined computing system to determine the network topology of the defined computing system.

Based on the topology of the defined computing system, data request unit 92 of monitor device 80 may facilitate storage of the data blocks of data set 114 across the computing devices arranged in the network topology within the defined computing system in a distributed fashion. In some examples, data request unit 92 may transmit the data blocks of data set 114 via communication units 84 directly to one or more of the computing devices within the defined computing system for distributed storage, without further interaction with user device 100. In other examples, user device 100 may perform some or all of the functions and/or operations attributed to monitor device 80.

In order to facilitate retrieval of the data blocks of data set 114 from distributed storage within the defined computing system, data request unit 92 of monitor device 80 may send a request to access data set 114 including the data set identifier to one or more of the computing devices within the defined computing system. In some examples, data request unit 92 may send a broadcast message carrying the retrieval request for data set 114 via communication units 84 to each of the computing devices within the defined computing system. In another example, data request unit 92 may publish a publish-subscribe message carrying the retrieval request for data set 114 to a topic associated with the data set identifier via communication unit 84 such that computing devices within the defined computing system that subscribe to the topic associated with the data set identifier receive the retrieval request. In other examples, data request unit 92 may send the retrieval request for data set 114 directly to a designated one of the computing devices within the defined computing system.

In some examples, after receipt of the retrieved data blocks of data set 114 from one or more of the computing devices within the defined computing system, monitor device 80 may send the retrieved data blocks of data set 114 to user device 100 for decryption and reassembly into data set 114. In other examples, after receipt of the retrieved data blocks of data set 114 from one or more of the computing devices within the defined computing system, data block unit 90 of monitor device 80 may decrypt the fragments within each of the retrieved data blocks using a decryption key of the one or more encryption keys associated with the data set identifier of data set 114 and/or associated with the encryption key included in the metadata of the respective one of the data blocks. Data block unit 90 may then reassemble data set 114 from the retrieved data blocks based on the instructions included in the metadata of the data blocks. Monitor device 80 may send the reassembled data set 114 to user device 100.

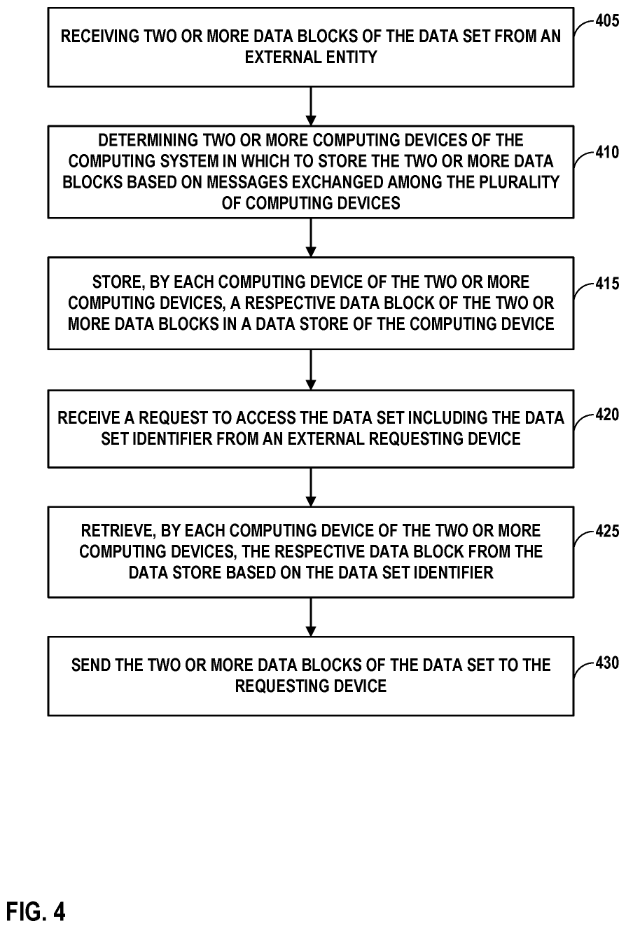

In some scenarios, at least data request unit 92 of monitor device 80 may comprise a virtual instance hosted on monitor device 80 specifically to facilitate storage and retrieval of data set 114 with the defined computing system. For example, after receipt of the request for secure storage of data set 114 and/or the request for retrieval of data set 114, monitor device 80 may create the virtual instance. Subsequently, after receipt of an acknowledgment that the data blocks of data set 114 are stored across the defined computing system and/or after receipt of the retrieved data blocks of data set 114 from the defined computing system, monitor device 80 may terminate the virtual instance. In other scenarios, the additional functions described with respect to FIG. 4 as being performed by data block unit 80, topology engine 94, and/or security unit 96 may also be performed by the virtual instance.

Modules illustrated in FIG. 3 (e.g., storage application 110 of user device 100, and data block unit 90, data request unit 92, topology engine 94, and security unit 96 of monitor device 80) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 4 is a flowchart illustrating an example operation of a computing system including a plurality of computing devices arranged in a network topology configured to store data blocks of a data set in a distributed fashion across the computing devices, in accordance with the techniques of this disclosure. The example operation of FIG. 4 is described with respect to computing system 24 including computing devices 14 from FIG. 1. In other examples, the operation of FIG. 4 may be performed by computing device 30 as one computing device within a computing system.

Computing system 24 may receive two or more data blocks 18 of a data set 17 from an entity external to the computing system 24, e.g., user device 16A or third-party system 28 (405). Each data block of the two or more data blocks 18 includes at least one fragment of two or more fragments of data set 17 and metadata including a data set identifier and instructions for reassembling data set 17 from the two or more data blocks 18. In some examples, either user device 16A, third-party system 28, or monitor device 22 may generate the two or more data blocks 18 by splitting data set 17 into two or more fragments, encrypting the two or more fragments with at least one encryption key, and packaging the encrypted fragments and the metadata into the two or more data blocks 18. In these examples, the metadata of each data block may further include the at least one encryption key used to encrypt the at least one fragment included in the respective data block.

Computing system 24 then stores the two or more data blocks 18 of data set 17 across two or more computing devices of the plurality of computing devices 14. In order to store data blocks 18 in a distributed fashion across computing devices 14, computing system 24 may determine two or more computing devices, e.g., 14A, 14B, 14C, of the plurality of computing devices 14 in which to store the two or more data blocks 18 based on messages exchanged among the plurality of computing devices 14 (410). In some examples, computing system 24 determines the two or more computing devices 14A, 14B, 14C based on capability information for each computing device included in the exchanged messages, where the capability information comprises one or more of data storage capacity or physical location within the network topology of the computing system 24.

Each computing device of the two or more computing devices 14A, 14B, 14C may store a respective data block 18A, 18B, 18C of the two or more data blocks 18 in a data store of the computing device (415). According to the disclosed techniques, the storage location information, e.g., addresses of computing devices 14A, 14B, 14C, for the two or more data blocks 18 may only be known by the plurality of computing devices 14 of computing system 24 and not known by any computing devices external to computing system 24. In addition, even within computing system 24, the storage location information of data blocks 18 may not be stored or maintained in a centralized manner. In one example, computing system 24 may securely record the storage location information for the two or more data blocks 18 in a distributed ledger or blockchain available to or provided by computing system 24. In this example, computing device 14A, for example, may encrypt the addresses of the two or more computing devices 14A, 14B, 14C with at least one encryption key associated with the data set identifier of data set 17, and record the encrypted addresses of the two or more computing devices 14A, 14B, 14C in at least one block of the blockchain available to or provided by computing system 24.

After storing the data blocks 18 across computing devices 14, computing system 24 may subsequently receive a request to access data set 17 including the data set identifier from a requesting device external to the computing system 24, e.g., monitor device 22 (420). In response to the request, each computing device of the two or more computing devices 14A, 14B, 14C retrieves the respective data block 18A, 18B, 18C from the data store of the computing device based on the data set identifier (425). Computing system 24 then sends the two or more data blocks 18 of data set 17 to the requesting device (430).

In some examples, each of computing devices 14A, 14B, 14C may, when storing the respective data block 18A, 18B, 18C in the data store of the computing device, store the respective data block in a record within the data store of the computing device, and create an index to the record with the data set identifier included in the metadata of the respective data block as an index key. After receipt of the request to access the data set including the data set identifier, each of computing devices 14A, 14B, 14C may then retrieve the respective data block 18A, 18B, 18C from the record within the data store of the computing device using the data set identifier from the request as the index key of the record within the data store.

In one scenario, each computing device of the plurality of computing devices 14 may receive a broadcast message carrying the request to access the data set 17 including the data set identifier from the requesting device. In another scenario, at least computing devices 14A, 14B, 14C that are storing the data blocks 18 associated with the data set identifier may receive a publish-subscribe message carrying the request to access the data set including the data set identifier. In this scenario, the requesting device, e.g., monitor device 22, comprises a publisher of the message to a topic associated with the data set identifier and at least computing devices 14A, 14B, and 14C comprise subscribers to the topic associated with the data set identifier. In either scenario, each computing device within computing system 24 that receives the retrieval request may look up the data set identifier and retrieve any corresponding data blocks in its data store without computing system 24 needing to determine the storage locations of the data blocks 18 associated with the data set identifier. In another scenario in which the storage location information is securely recorded in the blockchain, first computing device 14A, for example, may receive the request to access the data set 17 including the data set identifier from the requesting device and, in response, decrypt the addresses of the two or more computing devices 14A, 14B, 14C from the at least one block of the blockchain with at least one decryption key associated with the data set identifier and assigned to the first computing device 14A. First computing device 14A may then use the decrypted addresses of the two or more computing devices to instruct the two or more computing devices 14A, 14B, 14C to retrieve the two or more data blocks 18.

In some examples, the requesting device comprises a virtual instance hosted on a computing device external to computing system 24, e.g., monitor device 22. Monitor device 22 may create the virtual instance in response to a request for at least a portion of the data set 17 from an entity, e.g., one of user devices 16 or third-party system 28. Monitor device 22 may then terminate the virtual instance after receipt of the two or more data blocks 18 of data set 17 from computing system 24. In some examples, monitor device 22 may then send the data blocks 18 to the one of user devices 16 or third-party systems 28. In other examples, monitor device 22 may reassemble data set 17′ from the two or more data blocks 18, and send data set 17′ to the one of user devices 16 or third-party systems 28.

In further examples, prior to storing the two or more data blocks 18, first computing device 14A, for example, may calculate a first hash value of the two or more data blocks 18 of data set 17. After receipt to the request to access data set 17, computing system 24 may send the first hash value along with the two or more data blocks 18 to monitor device 22. Monitor device 22 may calculate a second hash value of the two or more data blocks 18 using the same hash function, and then validate the two or more data blocks 18 based on comparing the first and second hash values.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

1. A method comprising:
determining two or more computing devices of a plurality of computing devices in which to store two or more data blocks of a data set based on messages exchanged among the plurality of computing devices, wherein the plurality of computing devices are interconnected in a network topology, and wherein each data block of the two or more data blocks comprises at least one fragment of two or more fragments of the data set and metadata including a data set identifier and instructions for reassembling the data set from the two or more data blocks;
storing, by a first computing device of the two or more computing devices, a first data block of the two or more data blocks at a first storage location in a data store of the first computing device;
storing, by a second computing device of the two or more computing devices, a second data block of the two or more data blocks at a second storage location in a data store of the second computing device, wherein the first and second storage locations of the two or more data blocks are known only by the plurality of computing devices in the network topology and are unknown to devices external to the network topology, and wherein the first and second storage locations of the two or more data blocks are not maintained in a centralized manner;
based on receipt of a request to access the data set including the data set identifier from a requesting device external to the network topology:
retrieving, by the first computing device of the two or more computing devices, the first data block from the first storage location in the data store of the first computing device based on the data set identifier, and
retrieving, by the second computing device of the two or more computing devices, the second data block from the second storage location in the data store of the second computing device based on the data set identifier; and
sending, by the two or more computing devices, the two or more data blocks of the data set to the requesting device external to the network topology.

2. The method of claim 1,
wherein storing the first data block at the first storage location in the data store of the first computing device comprises storing the first data block in a record within the data store of the first computing device, and creating an index to the record with the data set identifier included in the metadata of the respective first data block as an index key; and
wherein retrieving the first data block at the first storage location from the data store comprises retrieving, by the first computing device, the first data block from the record within the data store of the first computing device using the data set identifier from the request as the index key of the record within the data store.

3. The method of claim 1, wherein determining the two or more computing devices of the plurality of computing devices in which to store the two or more data blocks of the data set comprises determining the two or more computing devices based on capability information for each computing device of the plurality of computing devices included in the exchanged messages, wherein the capability information comprises one or more of data storage capacity or physical location within the network topology.

4. The method of claim 1, further comprising securely recording, by the plurality of computing devices in the network topology, storage location information for the two or more data blocks, wherein the storage location information comprises addresses of the two or more computing devices storing the two or more data blocks.

5. The method of claim 4, wherein securely recording the storage location information comprises, after determining the two of more computing devices in which to store the two or more data blocks:
encrypting, by the first computing device, the addresses of the two or more computing devices with at least one encryption key associated with the data set identifier; and
recording, by the first computing device, the encrypted addresses of the two or more computing devices in at least one block of a blockchain available to the plurality of computing devices in the network topology.

6. The method of claim 5, further comprising:
receiving, by the first computing device and from the requesting device, the request to access the data set including the data set identifier;
decrypting, by the first computing device, the addresses of the two or more computing devices from the at least one block of the blockchain with at least one decryption key associated with the data set identifier and assigned to the first computing device; and
instructing, by the first computing device and based on the decrypted addresses of the two or more computing devices, the two or more computing devices to retrieve the two or more data blocks.

7. The method of claim 1, further comprising receiving, by each computing device of the plurality of computing devices in the network topology and from the requesting device, a broadcast message carrying the request to access the data set including the data set identifier.

8. The method of claim 1, further comprising receiving, by at least the two or more computing devices of the plurality of computing devices and from the requesting device, a publish-subscribe message carrying the request to access the data set including the data set identifier, wherein the requesting device comprises a publisher of the message to a topic associated with the data set identifier and at least the two or more computing devices comprise subscribers to the topic associated with the data set identifier.

9. The method of claim 1, further comprising receiving, by the plurality of computing devices in the network topology, the two or more data blocks of the data set from an entity external to the network topology.

10. The method of claim 1, wherein the requesting device comprises a virtual instance hosted on a computing device external to the network topology, wherein the computing device creates the virtual instance in response to a request for at least a portion of the data set from an entity, and wherein the computing device terminates the virtual instance based on receipt of the two or more data blocks of the data set from the two or more computing devices.

11. The method of claim 1, further comprising:
prior to storing the two or more data blocks, calculating, by the first computing device, a hash value of the two or more data blocks of the data set; and
based on receipt of the request to access the data set, sending, by the two or more computing devices and to the requesting device, the hash value of the two or more data blocks, wherein the requesting device validates the two or more data blocks based on the received hash value.

12. The method of claim 1, wherein the two or more fragments of the data set are encrypted with at least one encryption key, and wherein the metadata of the first data block further includes the at least one encryption key used to encrypt the at least one fragment included in the first data block.

13. A computing system comprising a plurality of computing devices interconnected in a network topology, wherein the plurality of computing devices is configured to:
determine two or more computing devices of the plurality of computing devices in which to store two or more data blocks of a data set based on messages exchanged among the plurality of computing devices, wherein each data block of the two or more data blocks comprises at least one fragment of two or more fragments of the data set and metadata including a data set identifier and instructions for reassembling the data set from the two or more data blocks;
wherein the two or more computing devices include:
a first computing device configured to store a first data block of the two or more data blocks at a first storage location in a data store of the first computing device, and
a second computing device configured to store a second data block of the two or more data blocks at a second storage location in a data store of the second computing device, wherein the first and second storage locations of the two or more data blocks are known only by the plurality of computing devices in the network topology and are unknown to devices external to the network topology, and wherein the first and second storage locations of the two or more data blocks are not maintained in a centralized manner;
receive of a request to access the data set including the data set identifier from a requesting device external to the network topology, wherein based on the request:
the first computing device is configured to retrieve the first data block from the first storage location in the data store of the first computing device based on the data set identifier, and
the second computing device is configured to retrieve the second data block from the second storage location in the data store of the second computing device based on the data set identifier; and
send, by the two or more computing devices, the two or more data blocks of the data set to the requesting device external to the network topology.

14. The computing system of claim 13,
wherein to store the first data block at the first storage location in the data store of the first computing device, the first computing device is further configured to store the first data block in a record within the data store of the first computing device, and create an index to the record with the data set identifier included in the metadata of the first data block as an index key; and
wherein to retrieve the first data block from the data store at the first storage location, the first computing device is further configured to, based on the request to access the data set including the data set identifier, retrieve the first data block from the record within the data store of the first computing device using the data set identifier from the request as the index key of the record within the data store.

15. The computing system of claim 13, wherein to determine the two or more computing devices of the plurality of computing devices in which to store the two or more data blocks of the data set, the plurality of computing devices is further configured to determine the two or more computing devices based on capability information for each computing device of the plurality of computing devices included in the exchanged messages, wherein the capability information comprises one or more of data storage capacity or physical location within the network topology.

16. The computing system of claim 13, wherein the plurality of computing devices is further configured to securely record storage location information for the two or more data blocks of the data set, wherein the storage location information comprises addresses of the two or more computing devices storing the two or more data blocks.

17. The computing system of claim 13, wherein the plurality of computing devices is further configured to receive, by each computing device of the plurality of computing devices and from the requesting device, a broadcast message carrying the request to access the data set including the data set identifier.

18. The computing system of claim 13, wherein the plurality of computing devices is configured to receive, by at least the two or more computing devices of the plurality of computing devices and from the requesting device, a publish-subscribe message carrying the request to access the data set including the data set identifier, wherein the requesting device comprises a publisher of the message to a topic associated with the data set identifier and at least the two or more computing devices comprise subscribers to the topic associated with the data set identifier.

19. The computing system of claim 13, wherein the plurality of computing devices is further configured to receive the two or more data blocks of the data set from an entity external to the network topology.

20. Non-transitory computer-readable media comprising instructions that, when executed, cause processing circuitry of a plurality of computing devices to:
determine two or more computing devices of the plurality of computing devices in which to store two or more data blocks of a data set based on messages exchanged among the plurality of computing devices, wherein the plurality of computing devices are interconnected in a network topology, and wherein each data block of the two or more data blocks comprises at least one fragment of two or more fragments of the data set and metadata including a data set identifier and instructions for reassembling the data set from the two or more data blocks;
store, by a first computing device of the two or more computing devices, a first data block of the two or more data blocks at a first storage location in a data store of the first computing device;
store, by a second computing device of the two or more computing devices, a second data block of the two or more data blocks at a second storage location in a data store of the second computing device, wherein the first and second storage locations of the two or more data blocks are known only by the plurality of computing devices in the network topology and are unknown to devices external to the network topology, and wherein the first and second storage locations of the two or more data blocks are not maintained in a centralized manner;
based on receipt of a request to access the data set including the data set identifier from a requesting device external to the network topology:
retrieve, by the first each computing device of the two or more computing devices, the first data block from the first storage location in the data store of the first computing device based on the data set identifier, and
retrieve, by the second computing device of the two or more computing devices, the second data block from the second storage location in the data store of the second computing device based on the data set identifier; and
send, by the two or more computing devices the two or more data blocks of the data set to the requesting device external to the network topology.
